(19) United States
(12) Patent Application Publication
(10) Pub. No.: US 2021/0354642 A1
(43) Pub. Date: Nov. 18, 2021

(54) SPACE MANAGEMENT SYSTEM, MOBILE BODY, COMPUTER READABLE RECORDING MEDIUM, AND SPACE MANAGEMENT METHOD

(71) Applicant: HONDA MOTOR CO.,LTD., Tokyo (JP)

(72) Inventors: Satoshi ONODERA, Tokyo (JP); Wataru AIKO, Tokyo (JP); Mafuyu KOSEKI, Tokyo (JP); Kazunori TOKUNAGA, Tokyo (JP); Toshiaki TAKANO, Tokyo (JP); Takahiro OYAMA, Tokyo (JP)

(21) Appl. No.: 17/388,032

(22) Filed: Jul. 29, 2021

Related U.S. Application Data
(63) Continuation of application No. PCT/JP2019/003754, filed on Feb. 1, 2019.

(51) Int. Cl. B60R 16/037; G10K 11/175; G06F 3/16; B60H 3/00; B60Q 3/80; B60N 2/04; B60N 2/20; B60N 2/01; B60H 3/06; B60H 1/00; B60R 13/08

(52) U.S. Cl. CPC B60R 16/0373; G10K 11/1754; G06F 3/165; B60H 3/00; B60Q 3/80; G10L 25/51; B60N 2/20; B60N 2/01; B60H 3/06; B60H 1/00828; B60R 13/0815; B60N 2/04

(57) ABSTRACT

A space management system for managing an environment of a shared space that is arranged inside a mobile body and can be used jointly by a first occupant and a second occupant comprises a control mode determining unit configured to determine a control mode serving as a control target of an adjusting unit configured to adjust the environment of the shared space. The control mode determining unit is configured to determine enabling or disabling of an independent control mode for independently adjusting an environment of a first subspace, which is a part of the shared space, where the first occupant is present and an environment of a second subspace, which is a part of the shared space, where the second occupant is present.

The contents of the following international application are incorporated herein by reference:
NO. PCT/JP2019/003754 filed in WO on Feb. 1, 2019.

### BACKGROUND

### 1. Technical Field

The present invention relates to a space management system, a mobile body, a computer readable recording medium, and a space management method.

### 2. Related Art

A vehicle air conditioning apparatus is known, which can achieve improvement of fuel consumption of a vehicle by reducing a heater heat amount for the entire vehicle while preferentially heating a driver by changing a radiating heat amount for a driver's seat and for a spot other than the driver's seat, such as a front passenger's seat (for example, see Patent Document 1).

### PRIOR ART DOCUMENT

[Patent Document]

[Patent Document 1] Japanese Patent Application Publication No. 2012-001200

### BRIEF DESCRIPTION OF THE DRAWINGS

FIG. 1 schematically shows an example of system configuration of a vehicle 100.

FIG. 2 schematically shows an example of a cabin space 120.

FIG. 3 schematically shows an example of the cabin space 120.

FIG. 4 schematically shows an example of the cabin space 120.

FIG. 5 schematically shows an example of an internal configuration of an input/output system 150.

FIG. 6 schematically shows an example of an internal configuration of an environment adjusting system 160.

FIG. 7 schematically shows an example of an internal configuration of a control system 170.

FIG. 8 schematically shows an example of a mode transition in the vehicle 100.

FIG. 9 schematically shows an example of a space management method in the vehicle 100.

FIG. 10 schematically shows an example of the space management method in the vehicle 100.

FIG. 11 schematically shows an example of the space management method in the vehicle 100.

FIG. 12 schematically shows an example of the space management method in the vehicle 100.

FIG. 13 schematically shows an example of a seat 212.

FIG. 14 schematically shows an example of a system configuration of a computer 3000.

### DESCRIPTION OF EXEMPLARY EMBODIMENTS

The present invention will be described below through embodiments of the invention, but the following embodiment does not limit the invention according to the claims. Moreover, not all combinations of features described in the embodiments are necessary to solutions of the invention. Note that identical or similar portions in figures are given identical reference numbers and the same explanation is omitted in some cases.

[Outline of Vehicle 100]

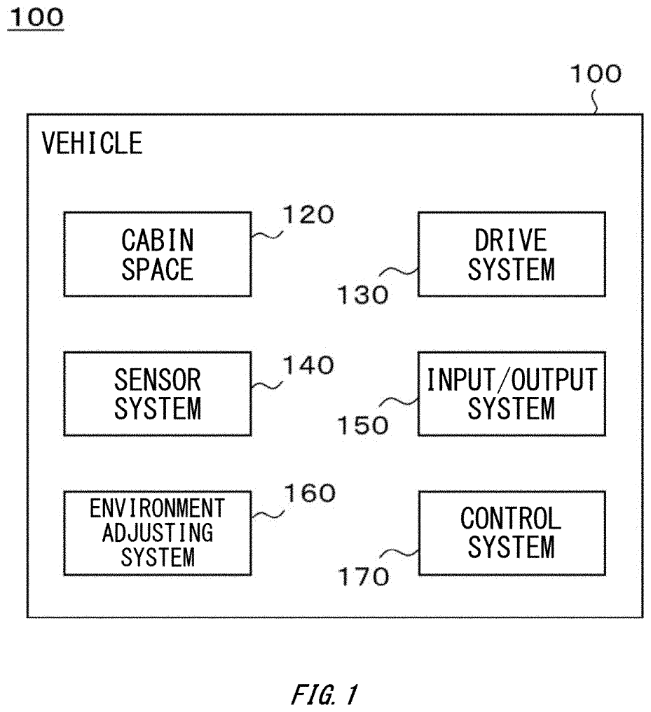

FIG. 1 schematically shows an example of a system configuration of a vehicle 100. In the present embodiment, the vehicle 100 includes a cabin space 120 in the inside thereof. In the present embodiment, the vehicle 100 includes a drive system 130, a sensor system 140, an input/output system 150, an environment adjusting system 160, and a control system 170.

The vehicle 100 is configured to move with one or more persons or objects loaded thereon. The vehicle 100 may move according to an operation by a driver riding in the vehicle 100, may move according to a remote operation, or may move according to automated driving.

Examples of the vehicle 100 include an automobile, a motorcycle, an electric train, or the like. Examples of the automobile include an engine vehicle, an electric vehicle, a fuel cell vehicle, a hybrid vehicle, a work machine, or the like. Examples of the motorcycle include (i) a motor bike, (ii) a three-wheeled motor bike, and (iii) a standing ride two-wheeled or three-wheeled vehicle with a power unit, or the like.

In the present embodiment, the vehicle 100 is configured to manage an environment of the cabin space 120. For example, the vehicle 100 is configured to independently manage an environment of each of a plurality of regions (each region may be referred to as a subspace) inside the cabin space 120. Examples of the above-described environment include a state of sight (which may be referred to as a sight environment), a state of sound (which may be referred to as a sound environment), a state of air (which may be referred to as an air environment), or the like. This promotes or suppresses communication between a plurality of occupants sharing the cabin space 120.

For example, in a case where the vehicle 100 transports a plurality of occupants, one occupant may want to promote communication with another occupant who is sharing the cabin space with her/him, or may want to suppress communication with the another occupant. Specifically, one occupant may want to share at least one of visual experience, auditory experience, and olfactory experience with the above-described another occupant, or may not want to share at least one of visual experience, auditory experience, and olfactory experience with the another occupant.

More specifically, in a case where a group consisting of a plurality of persons goes on a trip by using the vehicle 100, on an outward trip, promoting communication between the plurality of occupants may produce a sense of unity between the occupants. On the other hand, on a return trip, some occupants may want to have a good rest by suppressing communication with another occupant. Moreover, for example, in a case where the vehicle 100 is a shared bus or a shared taxi, there is a demand that an occupant does not want conversation with his/her acquaintance to be heard by a stranger. Moreover, there is a demand that an occupant want to eat a meal without worrying about the surroundings.

In the vehicle 100 according to the present embodiment, the environment of a space where one occupant is present and the environment of a space where another occupant is present are managed independently of each other. Specifically, at least one of (i) a range of sight of each occupant or goodness of the sight, (ii) a reaching range of a voice of each occupant or the sound volume of the voice, and (iii) the diffusion range of an odor substance generated by each occupant or the concentration or sensory intensity of the odor substance is adjusted. Thus, a degree of sharing at least one of visual experience, auditory experience, and olfactory experience between the one occupant and the another occupant is adjusted.

For example, the diffusion range of an odor substance is defined as a region where the concentration of the odor substance is higher than a predetermined threshold. The odor substance may be a chemical substance in the form of gas. The odor substance may be a causative substance of unpleasant smell such as bad odor or irritating odor, or may be a causative substance of comfortable fragrant.

[Outline of Each Unit of Vehicle 100]

In the present embodiment, the cabin space 120 is arranged inside the vehicle 100. The cabin space 120 may be a space that can be used jointly by a plurality of occupants. Details of the cabin space 120 will be described below.

In the present embodiment, the drive system 130 is configured to drive the vehicle 100. For example, the drive system 130 is configured to drive the vehicle 100 based on a command from the control system 170. In one embodiment, the drive system 130 is configured to drive the vehicle 100 based on an operation by the driver riding in the vehicle 100

In another embodiment, the drive system 130 has a remote operation function or an automated driving function.

In the present embodiment, the sensor system 140 includes various sensors. The sensor system 140 may send an output of each sensor to the control system 170.

The sensor system 140 may include a sensor for detecting a state outside the vehicle 100. The sensor system 140 may include a sensor for detecting a state of the cabin space 120. The sensor system 140 may include a sensor for detecting a state of each of one or more subspaces arranged inside the cabin space 120. Examples of the state detected by various sensors include (i) at least one of temperature, humidity, and cleanliness of air, (ii) illuminance, (iii) a sound volume, (iv) the concentration of a particular odor substance, or the like.

The sensor system 140 may include a sensor for collecting information for use in self-location estimation of the vehicle 100. Examples of the above-described sensor include a GPS signal receiver, an acceleration sensor, a gyro sensor, an orientation sensor, a rotary encoder, or the like.

In the present embodiment, the input/output system 150 is configured to accept an input from the occupant of the vehicle 100. The input/output system 150 may send accepted information to the control system 170. The input/output system 150 is configured to output information to the occupant of the vehicle 100. The input/output system 150 may output information based on a command from the control system 170.

The input/output system 150 may have an image capturing device configured to capture an image of a situation outside the vehicle 100. The input/output system 150 may have an image capturing device configured to capture an image of a situation in the cabin space 120. The input/output system 150 may send image data of the image captured by the image capturing device to the control system 170.

The input/output system 150 may have a sound collection device configured to collect a sound outside the vehicle 100. The input/output system 150 may have a sound collection device configured to collect a sound in the cabin space 120. The input/output system 150 may send audio data of the sound collected by the sound collection device to the control system 170. Details of the input/output system 150 will be described below.

In the present embodiment, the environment adjusting system 160 is configured to adjust the environment of the cabin space 120. For example, the environment adjusting system 160 is configured to adjust the environment of the cabin space 120 by acting on at least one of a visual sense, an auditory sense, and an olfactory sense of the occupant who is present inside the cabin space 120. The environment adjusting system 160 may adjust the environment of the cabin space 120 by independently acting on at least one of the visual sense, the auditory sense, and the olfactory sense of each of a plurality of occupants who are present inside the cabin space 120. Details of the environment adjusting system 160 will be described below.

In the present embodiment, the control system 170 is configured to control each unit of the vehicle 100. In one embodiment, the control system 170 is configured to control an operation of the drive system 130. In another embodiment, the control system 170 is configured to control an operation of the environment adjusting system 160. For example, the control system 170 is configured to determine a control mode serving as a control target of the environment adjusting system 160. Moreover, the control system 170 is configured to control an operation of the environment adjusting system 160 based on the determined control mode.

The control system 170 may independently control the environment of each of a plurality of subspaces arranged inside the cabin space 120. For example, the control system 170 is configured to determine enabling or disabling of an independent control mode where the environment of each of the plurality of subspaces arranged inside the cabin space 120 is independently adjusted. For example, in a case where enabling of the independent control mode is determined, the control system 170 firstly determines a control mode applied to each subspace. Then, the control system 170 controls the environment adjusting system 160 to adjust the environment of each subspace based on the control target indicated by the control mode applied to the subspace.

In one embodiment, the control system 170 is configured to adjust the environment of each subspace such that an environment of one subspace and an environment of another subspace becomes the same or similar to each other. Thus, various types of experience may be shared by one occupant who is present in the one subspace and another occupant who is present in the another subspace. Moreover, for example, communication between the one occupant who is present in the one subspace and the another occupant who is present in the another subspace may be promoted.

In another embodiment, the control system 170 is configured to adjust the environment of each subspace such that an environment of one subspace and an environment of another subspace are different from each other. Thus, various types of experience may not be shared by the one occupant who is present in the one subspace and the another occupant who is present in the another subspace. Moreover, communication between the one occupant who is present in the one subspace and the another occupant who is present in the another subspace may be suppressed.

On the other hand, in a case where disabling of the independent control mode is determined, the control system 170 ends the independent control mode. Thus, the communication promoting effect or the communication suppressing effect also ends. Details of the control system 170 will be described below.

As described above, the control system 170 is configured to determine the control mode serving as the control target of the environment adjusting system 160. In this context, the environment adjusting system 160 may have a plurality of types of independent control modes. In this case, the control system 170 may determine one of the plurality of independent control modes as the control mode serving as the control target of the environment adjusting system 160. Examples of the plurality of independent control modes include (a) a suppression mode for adjusting the environment in the cabin space 120 such that communication between one occupant and another occupant is suppressed, (b) a promotion mode for adjusting the environment in the cabin space 120 such that communication between one occupant and another occupant is promoted, or the like.

The plurality of independent control modes may include a plurality of promotion modes having different degrees of promoting communication between the one occupant and the another occupant. Examples of the plurality of promotion modes include (i) a first promotion mode for assisting establishment of communication between one occupant and another occupant, (ii) a second promotion mode for assisting establishment of communication between one occupant and another occupant more powerfully than the first promotion mode, or the like. The second promotion mode may be a mode for forcibly establishing communication between the one occupant and the another occupant.

For example, in a case where the control system 170 controls an operation of the environment adjusting system 160 to control auditory experience of one occupant and another occupant, in the first promotion mode, conversation between the occupants is conveyed to each other with an amplified sound volume, or the environmental sound that causes a noise in the conversation is reduced so that the voice of a speaker is clearly conveyed. On the other hand, in the second promotion mode, at least one of positions and orientations of seats of one occupant and another occupant are adjusted such that both of the occupants face each other, or at least one of positions and orientations of seats of one occupant and another occupant are adjusted such that the distance between both of the occupants becomes smaller.

The plurality of independent control modes may include a plurality of suppression modes having different degrees of suppressing communication between one occupant and another occupant. Examples of the plurality of suppression modes include (i) a first suppression mode for diminishing communication between one occupant and another occupant, (ii) a second promotion mode for diminishing communication between one occupant and another occupant more powerfully than the first suppression mode, or the like. The second suppression mode may be a mode for shutting off communication of the one occupant and the another occupant.

For example, in a case where the control system 170 controls an operation of the environment adjusting system 160 to control auditory experience of one occupant and another occupant, in the first suppression mode, conversation between the occupants is conveyed to each other with a decreased sound volume, or the environmental sound that causes a noise in the conversation is amplified so that conveyance of the voice of a speaker is hampered. On the other hand, in the second suppression mode, at least one of positions and orientations of seats of one occupant and another occupant are adjusted such that both of the occupants face away from each other, or at least one of positions and orientations of seats of one occupant and another occupant are adjusted such that the distance between both of the occupants becomes greater.

The vehicle 100 may be an example of a mobile body. The vehicle 100 may be an example of a space management system. Each of the plurality of occupants may be an example of a first occupant or a second occupant. The one occupant may be an example of one of the first occupant or the second occupant. The another occupant may be an example of the other of the first occupant or the second occupant. The cabin space 120 may be an example of a shared space. The one subspace may be an example of one of a first subspace or a second subspace. The another subspace may be an example of the other of the first subspace or the second subspace. The drive system 130 may be an example of a driving unit. The input/output system 150 may be an example of an instruction accepting unit. The environment adjusting system 160 may be an example of an adjusting unit. The control system 170 may be an example of a space management system. The control system 170 may be an example of a control mode determining unit and an environment control unit.

Note that, in the present embodiment, details of the mobile body are described in a case where the mobile body is the vehicle 100 as an example. The mobile body is not limited to the vehicle 100 according to the present embodiment. Other examples of the mobile body include a marine vessel, a flight vehicle, or the like. Examples of the marine vessel include a ship, a hovercraft, a water bike, a submarine ship, a submarine boat, a water scooter, or the like. Examples of the flight vehicle include an airplane, an airship or a balloon, an aerostat, a helicopter, a drone, or the like.

[Specific Configuration of Each Unit of Vehicle 100]

In the present embodiment, each unit of the vehicle 100 may be implemented by hardware, may be implemented by software, or may be implemented by hardware and software. For example, in the present embodiment, the control system 170 is at least partially implemented by a computer mounted on the vehicle 100. Note that the control system 170 may be at least partially implemented by a single server or a plurality of servers. Each unit of the control system 170 may be at least partially implemented on a virtual server or a cloud system. Each unit of the control system 170 may be at least partially implemented by a personal computer or a mobile terminal. Examples of the mobile terminal can include a mobile phone, a smartphone, a PDA, a tablet, a notebook computer or a laptop computer, a wearable computer, or the like. Each unit of the control system 170 may store information by using a distributed ledger technology or a distributed network such as a block chain.

In a case where at least a part of the components constituting the vehicle 100 is realized by software, the component realized by said software may be realized by activating a program that defines the operation related to said component, in an information processing device having a common configuration. The information processing device of a common configuration as described above may include (i) a data processing device having a processor such as a CPU or a GPU, a ROM, a RAM, a communication interface, or the like, (ii) an input device such as a keyboard, a pointing device, a touch panel, a camera, a sound input device, a gesture input device, various sensors, or a GPS receiver, (iii) an output device such as a display device, an sound output device, or a vibration device, and (iv) a storage device (including an external storage device) such as a memory, an HDD, or an SSD.

In the information processing device of common configuration as described above, the data processing device or the storage device described above may store the program described above. The program is configured to, when executed by a processor, cause the information processing device described above to execute operations defined by the program. The program described above may also be stored in a non-transitory computer readable recording medium. The program described above may be stored in a computer-readable medium such as a CD-ROM, a DVD-ROM, a memory, or a hard disk, or may be stored in a storage device connected to a network.

The program described above may be a program for causing a computer to function as the vehicle 100 or a part thereof. The program described above may include a module that defines an operation of each unit of the vehicle 100. The program or module acts on the data processing device, input device, output device, storage device, etc., to accordingly cause the computer to function as each unit of the vehicle 100, or cause the computer to perform an information processing method at each unit of the vehicle 100. The program described above may be installed in the computer constituting at least a part of the vehicle 100 from a computer-readable medium or a storage device connected to a network. When the program described above is executed, the computer may function as at least a part of each unit of the vehicle 100. When the program described above is read into the computer, the information processing described in the program functions as a specific means in which software related to the program and various hardware resources in the vehicle 100 or a part thereof cooperate with each other. Thus, the concrete means described above realizes computation or processing of an information in accordance with the purpose of use of the computer in the present embodiment, thereby the vehicle 100 in accordance with said purpose of use will be established.

The program described above may be a program for causing a computer to function as the control system 170. The program described above may be a program for causing a computer to execute an information processing method in the control system 170.

The information processing method described above may be a space management method for managing an environment of a shared space. The shared space described above may be a space that is arranged inside the mobile body and can be used jointly by the first occupant and the second occupant. The space management method described above may include control mode determining step for determining a control mode serving as a control target of the adjusting unit configured to adjust the environment of the shared space. The control mode determining step described above may include a step of determining enabling or disabling of an independent control mode for independently adjusting an environment of a first subspace, which is a part of a shared space, where a first occupant is present and an environment of a second subspace, which is a part of the shared space, where a second occupant is present. The space management method described above may include an environment control step for controlling an operation of the adjusting unit based on the control mode determined in the control mode determining step.

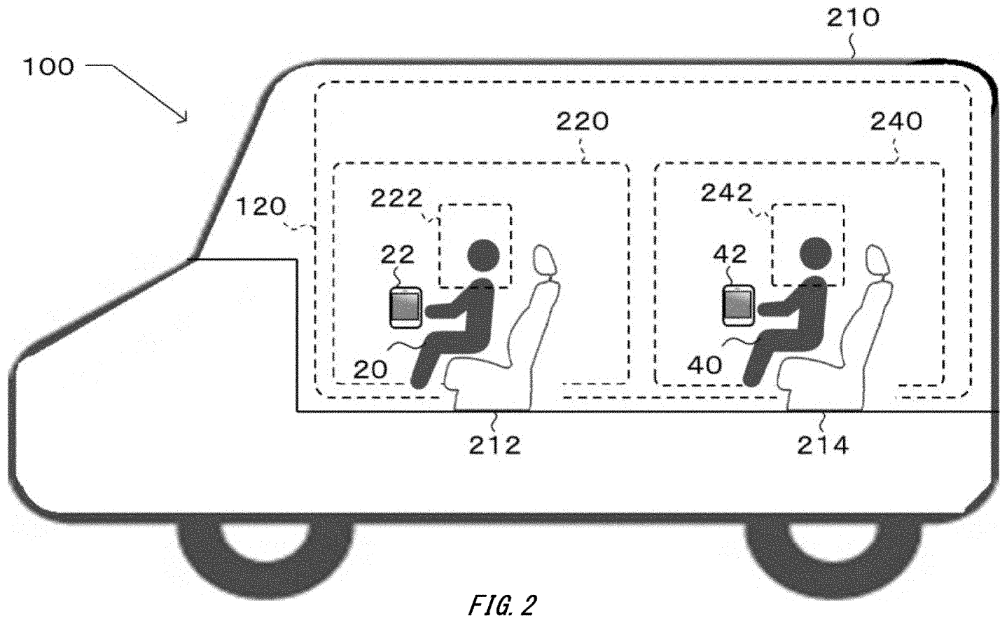

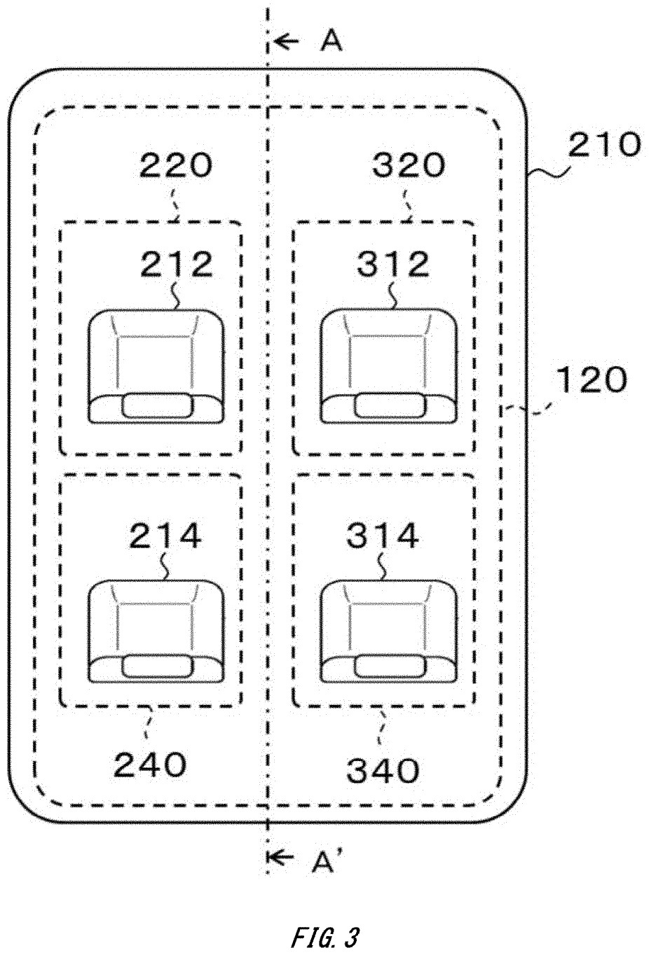

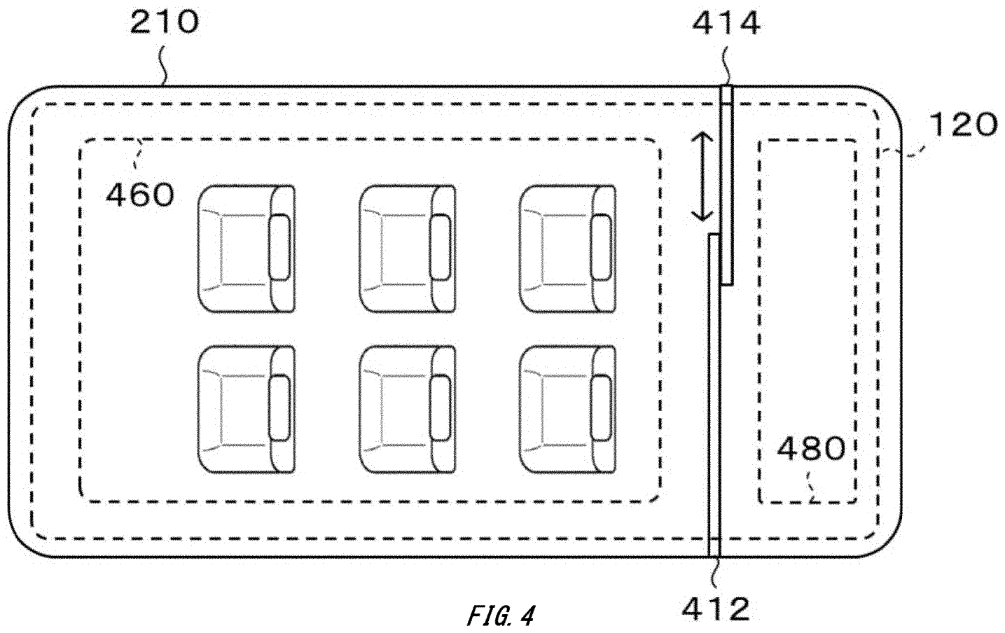

Details of the cabin space 120 will be described by using FIG. 2, FIG. 3, and FIG. 4. FIG. 2 schematically shows an example of a side view of the cabin space 120. FIG. 3 schematically shows an example of a top view of the cabin space 120. FIG. 2 may be an example of the cross-section A-A′ in FIG. 3. FIG. 4 schematically shows another example of a top view of the cabin space 120.

As shown in FIG. 2 and FIG. 3, a seat 212, a seat 214, a seat 312, and a seat 314 are arranged inside a housing 210 of the vehicle 100. In the example shown in FIG. 2, an occupant 20 is seated on the seat 212, and an occupant 40 is seated on the seat 214. The seat 312 may be a driver's seat of the vehicle 100. Note that the driver's seat is not limited to the seat 312. Moreover, in a case where the vehicle 100 moves by completely automated driving, the vehicle 100 may not include the driver's seat.

The occupant 20 inputs information to the control system 170 and receives information from the control system 170, via the input/output system 150. The occupant 20 may input information to the control system 170 and receive information from the control system 170, via the communication terminal 22.

The communication terminal 22 only needs to be an information processing device that can transmit and receive information to/from the control system 170, and details thereof are not particularly limited.

Examples of the communication terminal 22 include a personal computer, a mobile terminal, or the like. Examples of the mobile terminal include a mobile phone, a smartphone, a PDA, a tablet, a notebook computer or a laptop computer, a wearable computer, or the like.

The occupant 40 inputs information to the control system 170 and receives information from the control system 170, via the input/output system 150. The occupant 40 may input information to the control system 170 and receive information from the control system 170, via the communication terminal 42.

The communication terminal 42 only needs to be an information processing device that can transmit and receive information to/from the control system 170, and details thereof are not particularly limited. Examples of the communication terminal 42 include a personal computer, a mobile terminal, or the like. Examples of the mobile terminal include a mobile phone, a smartphone, a PDA, a tablet, a notebook computer or a laptop computer, a wearable computer, or the like.

As shown in FIG. 3, a subspace 220, a subspace 240, a subspace 320, and a subspace 340 are set inside the cabin space 120. The subspace 220 may be a part of the cabin space 120, which is a region where the seat 212 or the occupant 20 using the seat 212 is present. The subspace 240 may be a part of the cabin space 120, which is a region where the seat 214 or the occupant 40 using the seat 214 is present. The subspace 320 may be a part of the cabin space 120, which is a region where the seat 312 or the occupant using the seat 312 is present. The subspace 340 may be a part of the cabin space 120, which is a region where the seat 314 or the occupant using the seat 314 is present.

As shown in FIG. 2, a subspace 222 and a subspace 242 are set inside the cabin space 120. The subspace 222 may be a part of the subspace 220, which is a region where the head of the occupant 20 using the seat 212 is positioned. The size of the subspace 222 may be larger than the head of the occupant 20. The subspace 242 may be a part of the subspace 240, which is a region where the head of the occupant 40 using the seat 214 is positioned. The size of the subspace 242 may be larger than the head of the occupant 40.

Note that, also inside the subspace 320, as in the case with the subspace 220 and the subspace 240, a subspace may be set in the vicinity of the region where the head of the occupant using the seat 312 is positioned. Moreover, inside the subspace 340, a subspace may be set in the vicinity of the region where the head of the occupant using the seat 314 is positioned.

As described above, in the present embodiment, when the independent control mode is enabled, the environment inside the space is adjusted for each subspace. The vehicle 100 can adjust a cabin environment for each occupant, by setting the subspaces inside the cabin space 120 as described above.

As shown in FIG. 2 and FIG. 3, the cabin space 120 may be a space that can be used jointly by a plurality of occupants (which may be referred to as a shared space). Moreover, inside the cabin space 120, there is no space surrounded by a partition or a wall in all directions, which is a space for exclusive use by some of occupants of the vehicle 100 (which may be referred to as an isolated space).

The shared space, which is the cabin space 120, may be defined as a space other than the isolated space within a space where the occupant of the vehicle 100 can stay inside the housing 210. Note that the description above does not exclude an embodiment in which the isolated space is arranged inside the housing 210.

FIG. 4 shows an example of an embodiment in which the isolated space is arranged inside the housing 210. According to FIG. 4, an example of an embodiment is shown where the shared space and the isolated space are arranged adjacent to each other inside the vehicle 100. As shown in FIG. 4, the cabin space 120 is divided into a first space 460 and a second space 480 by a partition wall 412 and a door 414. Each of the first space 460 and the second space 480 is surrounded by the housing 210, the partition wall 412, and the door 414 in all directions.

In the present embodiment, a plurality of seats are arranged in the first space 460, and the seats can be used jointly by a plurality of occupants. On the other hand, the second space 480 may be exclusively used by some of the plurality of occupants during at least a certain time period. As shown in FIG. 4, although the isolated space is arranged inside the housing 210, there is no isolated space inside the first space 460. Moreover, as in the case with the cabin space 120 of the embodiments described in connection with FIG. 2 and FIG. 3, one or more subspaces may be set inside the first space 460. Then, the vehicle 100 may adjust, for each subspace set inside the first space 460, an environment inside the space.

The occupant 20 may be an example of one of the first occupant or the second occupant. The occupant 40 may be an example of the other of the first occupant or the second occupant. The subspace 220 may be an example of one of the first subspace or the second subspace. The subspace 240 may be an example of the other of the first subspace or the second subspace. Similarly, the occupant using the seat 312 may be an example of the first occupant or the second occupant. The occupant using the seat 314 may be an example of the first occupant or the second occupant. The subspace 320 may be an example of the first subspace or the second subspace. The first space 460 may be an example of the shared space. The second space 480 may be an example of the isolated space.

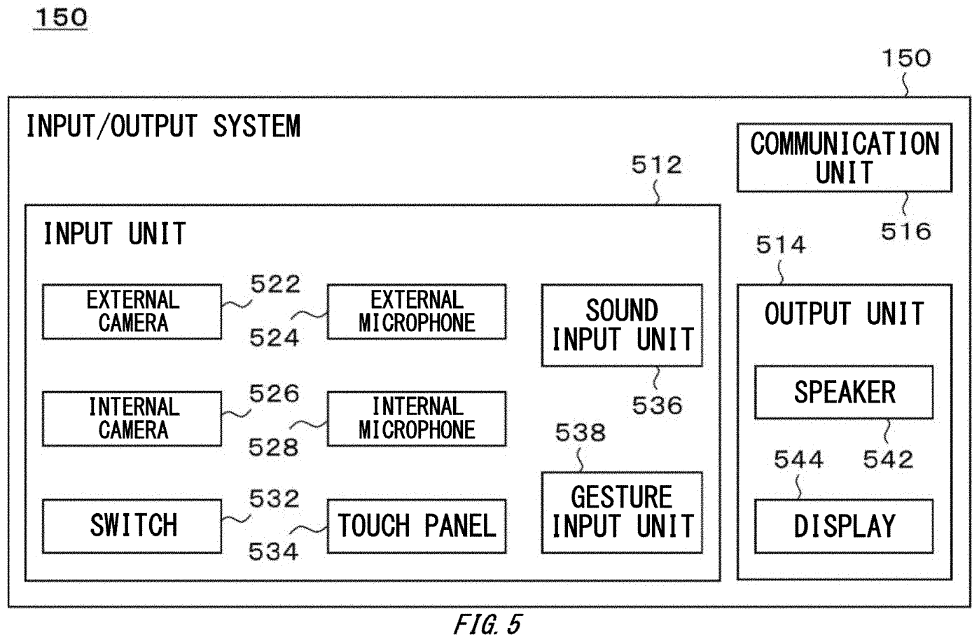

FIG. 5 schematically shows an example of an internal configuration of the input/output system 150. In the present embodiment, the input/output system 150 includes an input unit 512, an output unit 514, and a communication unit 516. In the present embodiment, the input unit 512 has one or more external cameras 522, one or more external microphones 524, one or more internal cameras 526, and one or more internal microphones 528. The input unit 512 has one or more switches 532, one or more touch panels 534, one or more sound input units 536, and one or more gesture input units 538. In the present embodiment, the output unit 514 has one or more speakers 542 and one or more displays 544.

In the present embodiment, the input unit 512 is configured to accept an input from at least one occupant among the plurality of occupants. The input described above may be an instruction from at least one of the occupant 20 and the occupant 40, the instruction being related to enabling, disabling, or switching of the independent control mode. The input described above may be a command from the driver of the vehicle 100 for conveying a message from the driver to another occupant.

The input unit 512 may acquire information indicating a situation outside the vehicle 100. The input unit 512 may acquire information indicating a situation inside the cabin space 120. The input unit 512 may send the input information to the control system 170.

In the present embodiment, the output unit 514 is configured to output information to the occupant of the vehicle 100. The output unit 514 may output information based on a command from the control system 170.

In the present embodiment, the communication unit 516 is configured to transmit and receive information to/from an external information processing device via a communication network. For example, the communication unit 516 is configured to transmit and receive information to/from a communication terminal of the occupant of the vehicle 100 (which is, for example, the communication terminal 22 or the communication terminal 42). The communication unit 516 may receive information input to the communication terminal by at least one occupant among the plurality of occupants. The communication unit 516 may send the received information to the control system 170.

The communication network may be a transmission path for wired communication, may be a transmission path for wireless communication, or may be a combination of a transmission path for wireless communication and a transmission path for wired communication. The communication network may include a wireless packet communication network, the Internet, a P2P network, a dedicated line, a VPN, an electrical power line communication line, or the like. The communication network may include a mobile communication network such as a mobile phone line network. The communication network may include a wireless data communication network, such as wireless MAN (for example, WiMAX (registered trademark)), wireless LAN (for example, WiFi (registered trademark)), Bluetooth (registered trademark), Zigbee (registered trademark) and NFC (Near Field Communication). The communication network may include a V2X communication line, such as inter-vehicle communication and road-vehicle communication.

In the present embodiment, the external camera 522 is configured to capture an image of a situation outside the vehicle 100. Thus, information outside the vehicle 100 is acquired. In the present embodiment, the external microphone 524 is configured to collect a sound outside the vehicle 100. Thus, information outside the vehicle 100 is acquired.

In the present embodiment, the internal camera 526 is configured to capture an image of a situation inside the cabin space 120. Thus, information indicating a gesture of one or more occupants is acquired. Each of a plurality of internal cameras 526 may capture an image of a situation in each of the plurality of subspaces, or a single internal camera 526 may capture an image of the situation in the plurality of subspaces.

In the present embodiment, the internal microphone 528 is configured to collect a sound inside the cabin space 120. Thus, information indicating a voice of one or more occupants is acquired. Examples of the information indicating a voice include information indicating a content of the voice, information indicating a sound volume of the voice, information indicating a change in the sound volume of the voice, information indicating an interval between speeches of the occupant, or the like.

Each of a plurality of internal microphones 528 may collect a voice in each of the plurality of subspaces, or a single internal microphone 528 may collect a voice in the plurality of subspaces. The internal microphone 528 may be a directional microphone.

In the present embodiment, the switch 532 is configured to accept an instruction from one or more occupants. For example, each of the one or more switches 532 is associated with a particular operation related to the vehicle 100. Each of the one or more switches 532 may be associated with a particular occupant.

In the present embodiment, the touch panel 534 is configured to accept an instruction from one or more occupants. For example, a particular region of the touch panel 534 is associated with a particular operation related to the vehicle 100. Each of the one or more touch panels 534 may be associated with a particular occupant.

In the present embodiment, the sound input unit 536 is configured to accept an instruction from one or more occupants by analyzing audio data acquired by the internal microphone 528. In the present embodiment, the gesture input unit 538 is configured to accept an instruction from one or more occupant by analyzing image data acquired by the internal camera 526.

In the present embodiment, the speaker 542 is configured to output audio information to each of the one or more occupants. Each of the one or more speakers 542 may be associated with a particular occupant. The speaker 542 may be directional.

In the present embodiment, the display 544 is configured to output an image to each of the one or more occupants. The image may be a video image or may be a still image. The image may be an upscaled image or may be a downscaled image. Each of the one or more displays 544 may be associated with a particular occupant.

The input unit 512 or each unit of the input unit 512 may be an example of the instruction accepting unit and the command accepting unit. The output unit 514 or each unit of the output unit 514 may be an example of the adjusting unit. The communication unit 516 may be an example of the instruction accepting unit. The external camera 522 may be an example of the external information acquiring unit and the image capturing device. The external microphone 524 may be an example of the external information acquiring unit and the sound collection device. The internal camera 526 may be an example of the occupant information acquiring unit and the image capturing device. The internal microphone 528 may be an example of the occupant information acquiring unit and the sound collection device.

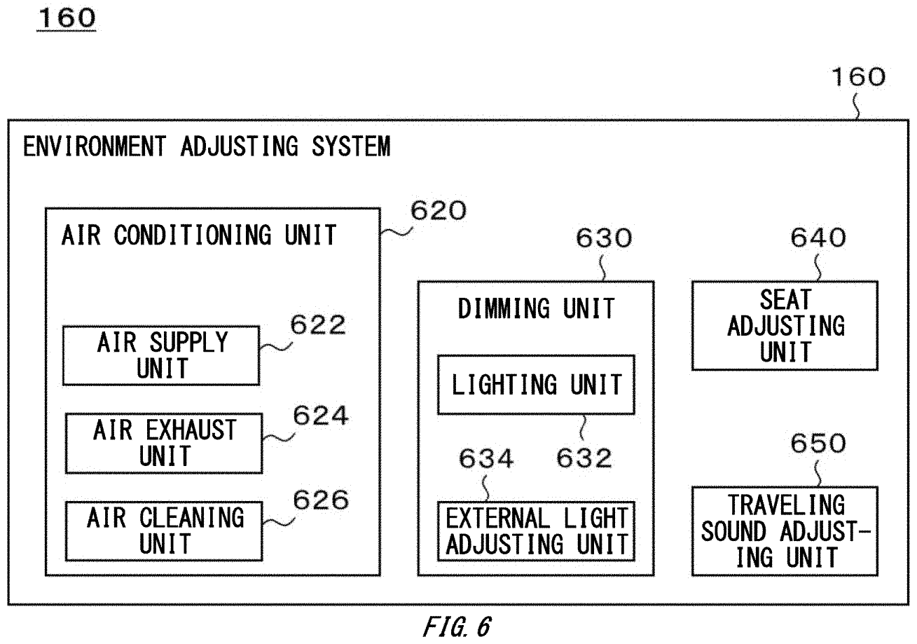

FIG. 6 schematically shows an example of an internal configuration of the environment adjusting system 160. In the present embodiment, the environment adjusting system 160 includes an air conditioning unit 620, a dimming unit 630, a seat adjusting unit 640, and a traveling sound adjusting unit 650. In the present embodiment, the air conditioning unit 620 has an air supply unit 622, an air exhaust unit 624, and an air cleaning unit 626. In the present embodiment, the dimming unit 630 has a lighting unit 632 and an external light adjusting unit 634. Each unit of the environment adjusting system 160 may be an example of the adjusting unit.

In the present embodiment, the air conditioning unit 620 is configured to adjust an air environment inside the cabin space 120. The air conditioning unit 620 may adjust an air environment in each of a plurality of subspaces arranged inside the cabin space 120. Examples of the air conditioning unit 620 include air conditioning equipment, a window, or the like. Operational details of each unit of the air conditioning unit 620 will be described below.

In the present embodiment, the air supply unit 622 is configured to supply air into the inside of the cabin space 120. The air supply unit 622 may supply air processed by the air cleaning unit 626 into the inside of the cabin space 120.

In the present embodiment, the air exhaust unit 624 is configured to discharge air from the inside of the cabin space 120 to the outside of the vehicle 100. The air exhaust unit 624 may supply air from the inside the cabin space 120 to the air cleaning unit 626.

In the present embodiment, the air cleaning unit 626 is configured to clean supplied air. For example, the air cleaning unit 626 is configured to clean air supplied from the air exhaust unit 624. The air cleaning unit 626 may supply cleaned air to the air supply unit 622.

In the present embodiment, the dimming unit 630 is configured to adjust a lighting environment in the cabin space 120. The dimming unit 630 may adjust a lighting environment in each of a plurality of subspaces arranged inside the cabin space 120. Operational details of each unit of the dimming unit 630 will be described below.

In the present embodiment, the lighting unit 632 is configured to irradiate light to the inside of the cabin space 120. The lighting unit 632 may include one or more lights. At least one of the one or more lights may be a spotlight.

In the present embodiment, the external light adjusting unit 634 is configured to adjust an amount of light entering the inside of the cabin space 120 from the outside of the vehicle 100. The external light adjusting unit 634 may adjust an amount of visible light entering the inside of the cabin space 120 from the outside of the vehicle 100. Examples of the external light adjusting unit 634 include a dimming glass, a movable light shielding member, or the like. Examples of a dimming method of the dimming glass include a liquid crystal type method, an electrochromic type method, or the like. Examples of the light shielding member include a curtain, a blind, or the like.

In the present embodiment, the seat adjusting unit 640 is configured to adjust a seat of the vehicle 100. For example, the seat adjusting unit 640 is configured to adjust at least one of a position and a posture of each seat. Examples of the posture of the seat include the orientation of the seat, the reclining angle of the seat, lifting and lowering of an armrest, or the like. The seat adjusting unit 640 may control a movement of a movable portion of each seat. Operational details of the seat adjusting unit 640 will be described below.

The traveling sound adjusting unit 650 is configured to adjust conveyance of a traveling sound into the inside of the cabin space 120. For example, the traveling sound adjusting unit 650 is configured to control an operation of a noise cancelling device configured to generate a cancelling sound for cancelling an engine sound, a motor sound, a road noise, or the like. The traveling sound adjusting unit 650 may control an operation of a vibration suppression device for suppressing conveyance of vibration of a tire to the vehicle body. Operational details of the traveling sound adjusting unit 650 will be described below.

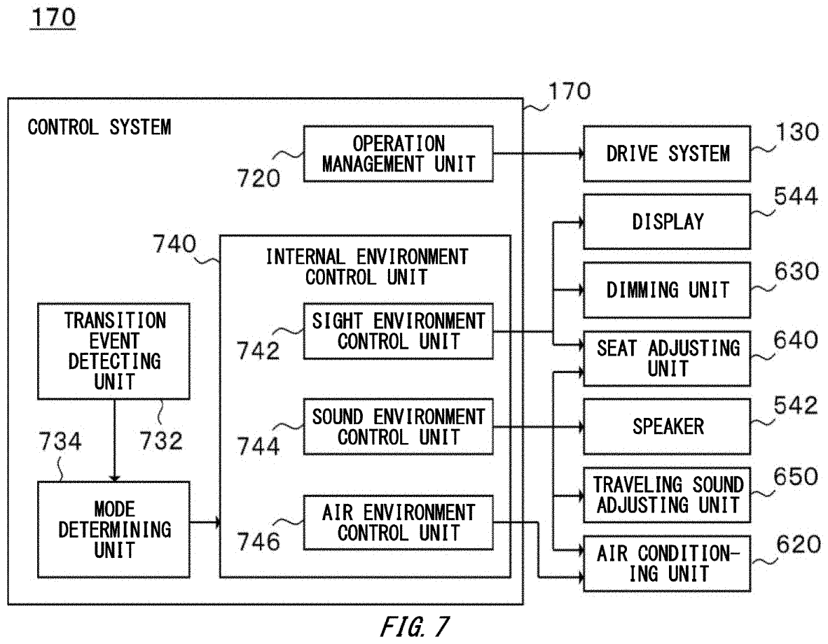

FIG. 7 schematically shows an example of an internal configuration of the control system 170. In the present embodiment, the control system 170 includes an operation management unit 720, a transition event detecting unit 732, a mode determining unit 734, and an internal environment control unit 740. In the present embodiment, the internal environment control unit 740 has a sight environment control unit 742, a sound environment control unit 744, and an air environment control unit 746.

In the present embodiment, the operation management unit 720 is configured to manage an operation of the vehicle 100. For example, the operation management unit 720 is configured to move the vehicle 100 by controlling the drive system 130. The operation management unit 720 may acquire information indicating a state of the drive system 130 from the drive system 130. The operation management unit 720 may acquire information indicating a current location of the vehicle 100 from the sensor system 140. The operation management unit 720 may acquire information indicating a destination of the vehicle 100 from the input/output system 150. The operation management unit 720 may send various types of information as described above to the transition event detecting unit 732.

In the present embodiment, the transition event detecting unit 732 is configured to detect an event related to a transition of the control mode of the environment adjusting system 160 (which may be referred to as a transition event). Examples of the transition of the control mode include enabling of the independent control mode, disabling of the independent control mode, switching between a plurality of independent control modes, or the like. The transition event detecting unit 732 may detect a transition event based on information acquired by each unit of the vehicle 100.

In one embodiment, when the input/output system 150 receives an instruction from at least one occupant among a plurality of occupants, the instruction being related to enabling, disabling, or switching of the independent control mode, the transition event detecting unit 732 acquires information indicating that the above-described instruction is input from the input/output system 150. The transition event detecting unit 732 may acquire information indicating a content of the above-described instruction. The information indicating a content of the instruction may be an example of information indicating that the instruction is input. When the transition event detecting unit 732 acquires information indicating that the above-described instruction is input, the transition event detecting unit 732 detects an occurrence of a transition event, and sends information indicating a content of the instruction to the mode determining unit 734. That the above-described instruction is input may be an example of the transition event.

In another embodiment, the transition event detecting unit 732 is configured to acquire, from the input/output system 150, information indicating at least one of a gesture and a voice of at least one occupant among the plurality of occupants. Examples of the gesture include a movement of the body, a facial expression, or the like. Examples of the body include the hands, the foots, the face, the head, the eyes, the mouth, or the like. The transition event detecting unit 732 is configured to detect an occurrence of a predetermined transition event (which may be referred to as a first event) based on the acquired information. For example, the transition event detecting unit 732 detects occurrence of the first event, when the transition event detecting unit 732 detects a predetermined pattern by analyzing at least one of the above-described gesture and voice.

The transition event detecting unit 732 may send information indicating that the first event has occurred to the mode determining unit 734. The transition event detecting unit 732 may send information indicating a content or a type of the first event to the mode determining unit 734.

Examples of the first event related to enabling of the promotion mode include (i) detection of an action of one occupant in which the one occupant directs his/her eyes, face, or body toward another occupant, (ii) detection of an action of one occupant in which the one occupant talks to another occupant, (iii) detection of an action of one occupant in which the one occupant touches another occupant, (iv) detection of an action of one occupant in which the one occupant takes the action for listening to another occupant's speech, (v) detection of an action of one occupant in which the one occupant makes a facial expression showing that it is difficult for the one occupant to listen to another occupant's speech, or the like. The action in which one occupant talks to another occupant may be an action in which the one occupant tries to talk to the another occupant. The action in which one occupant touches another occupant may be an action in which the one occupant tries to touch the another occupant.

Examples of the action in which the one occupant tries to talk to the another occupant or the action in which the one occupant tries to touch the another occupant include (i) an action in which the one occupant directs or stretches his/her hand or foot in the direction of the another occupant, (ii) an action in which the one occupant makes a particular facial expression, (iii) an action in which the one occupant moves his/her body away from the seat surface or the backrest surface of the seat, (iv) an action in which the one occupant lifts an armrest provided in the seat, or the like. Examples of the action in which the one occupant takes an action for listening to the another occupant's speech include an action in which the one occupant shows that he/she is concentrating on the speech, an action in which the one occupant gives a nod, or the like.

Examples of the first event related to enabling of the promotion mode include (i) the sound volume of a speech of one occupant being larger than a predetermined value, (ii) a content of a speech of one occupant containing the name or the title of another occupant, (iii) an intonation pattern of a speech of one occupant matching or being similar to a predetermined pattern, or the like. Examples of the predetermined pattern related to intonation include a pattern of calling another person, a pattern of involving elation or a positive emotion, or the like.

In a case where a content of a speech of one occupant contains the name or the title of another occupant, the promotion mode may be selected as the control mode for the subspace in which the another occupant is present, regardless of a current state of the control mode for the subspace in which the another occupant is present. In other words, the promotion mode of one occupant may override the suppression mode of another occupant.

In a case where a content of a speech of one occupant contains the name or the title of another occupant and the number of utterance or utterance frequency of the name or the title is higher than a predetermined value, the promotion mode may be selected as the control mode for the subspace in which the another occupant is present, regardless of a current state of the control mode for the subspace in which the another occupant is present. In a case where a content of a speech of one occupant contains the name or the title of another occupant and the sound volume of the speech is larger than a predetermined value, the promotion mode may be selected as the control mode for the subspace in which the another occupant is present, regardless of a current state of the control mode for the subspace in which the another occupant is present.

Examples of the first event related to enabling of the suppression mode include (i) detection of an action of one occupant in which the one occupant takes the action for blocking interference from another person, (ii) detection of one occupant being asleep or trying to sleep, (iii) detection of a degree of change in the body or facial expression of one occupant not satisfying a predetermined criterion, (iv) detection of one occupant sitting on the seat in a predetermined condition, (v) detection of a negative emotion by analyzing a gesture of one occupant, or the like. Examples of the action for blocking interference from another person include (i) an action of directing his/her face or body in a direction with no another person, (ii) an action of facing down, (iii) an action of blocking his/her ears with his/her hands or an item, (iv) an action of covering his/her face with his/her hands or an item, (v) an action of covering his/her nose with his/her hands or an item, (vi) an action of suppressing an action of another person, (vii) an action of deeply leaning against the backrest surface of the seat, (ix) an action of lowering the armrest of the seat, or the like.

Examples of the first event related to enabling of the suppression mode include (i) an interval between speeches of one occupant being larger than a predetermined value, (ii) a content of a speech of one occupant containing words for rejecting interference from another person, (iii) an intonation pattern of a speech of one occupant matching or being similar to a predetermined pattern, or the like. Examples of the predetermined pattern related to intonation include a pattern of rejecting interference from another person, a pattern of involving a negative emotion, or the like.

Similarly, a first event related to disabling of the promotion mode may be set. The first event related to enabling of the suppression mode may be used as the first event related to disabling of the promotion mode. Moreover, a first event related to disabling of the suppression mode may be set. The first event related to enabling of the promotion mode may be used as the first event related to disabling of the suppression mode.

A particular single event may be designated as a first event related to switching between a plurality of promotion modes, or a combination of a plurality of events may be used as the first event related to switching between the plurality of promotion modes. The combination of the plurality of events may be a particular combination or may be any combination. For example, in a case where a weight or a score is given in advance for each event and the sum value of the weight or the score of a detected event is higher than a predetermined threshold, the first event related to switching between the plurality of promotion modes is detected. Thus, any combination of the plurality of events may be used as the first event related to switching between the plurality of promotion modes.

Similarly, a particular single event may be designated as the first event related to switching between a plurality of suppression modes, or a combination of a plurality of events may be used as the first event related to switching between the plurality of suppression modes. The combination of the plurality of events may be a particular combination or may be any combination. For example, in a case where a weight or a score is given in advance for each event and the sum value of the weight or the score of a detected event is higher than a predetermined threshold, the first event related to switching between the plurality of suppression modes is detected. Thus, any combination of the plurality of events may be used as the first event related to switching between the plurality of suppression modes.

In another embodiment, the transition event detecting unit 732 is configured to acquire information indicating a state of the drive system 130 from the operation management unit 720. The transition event detecting unit 732 is configured to detect an occurrence of a predetermined transition event (which may be referred to as a second event) based on the acquired information. For example, the transition event detecting unit 732 detects occurrence of the second event, when the transition event detecting unit 732 detects a predetermined pattern by analyzing a state of the drive system 130.

The transition event detecting unit 732 may send information indicating that the second event has occurred to the mode determining unit 734. The transition event detecting unit 732 may send information indicating a content or a type of the second event to the mode determining unit 734. Examples of the predetermined pattern include a safety device being activated, setting of the seat being changed by an occupant, a window being closed or opened by an occupant, or the like.

In another embodiment, the transition event detecting unit 732 is configured to acquire information indicating a state outside the vehicle 100 from the input/output system 150. The transition event detecting unit 732 is configured to detect an occurrence of a predetermined transition event (which may be referred to as a third event) based on the acquired information. For example, the transition event detecting unit 732 detects occurrence of the third event, when the transition event detecting unit 732 detects a predetermined pattern by analyzing a state outside the vehicle 100.

The transition event detecting unit 732 may send information indicating that the third event has occurred to the mode determining unit 734. The transition event detecting unit 732 may send information indicating a content or a type of the third event to the mode determining unit 734. Examples of the predetermined pattern include an inter-vehicle distance relative to another vehicle being smaller than a predetermined value, an emergency vehicle being approaching, a particular land or building such as a sightseeing spot being present in the vicinity of the vehicle, or the like.

In the present embodiment, the mode determining unit 734 is configured to determine the control mode serving as the control target of the environment adjusting system 160. The mode determining unit 734 may send the determined control mode to the internal environment control unit 740.

The mode determining unit 734 may determine enabling, disabling, or switching of the independent control mode. The mode determining unit 734 may determine one of a plurality of independent control modes as the control mode serving as the control target described above. The mode determining unit 734 may determine the control mode serving as the control target described above based on a type or a content of a transition event detected by the transition event detecting unit 732.

When an event that contradicts the control mode of a particular subspace is detected, the mode determining unit 734 may determine which event should be prioritized. For example, the mode determining unit 734 may determine which event should be prioritized based on at least one of a type of the events, a combination of the events, and a detection frequency of the events.

For example, there is a case where the transition event detecting unit 732 (i) detects, based on a gesture of an occupant A, a first event X indicating that the promotion mode is to be set as the control mode for the subspace in which an occupant B is present and (ii) detects, based on a gesture of the occupant B, a first event Y indicating that the suppression mode is to be set as the control mode for the subspace in which the occupant B is present, at the same timing. In this case, for example, when the first event X is a predetermined type of event, the mode determining unit 734 determines to set the promotion mode as the control mode for the subspace in which the occupant B is present (which may be referred to as override), regardless of the current control mode for the subspace in which the occupant B is present and the type of another event related to the subspace in which the occupant B is present. The mode determining unit 734 may determine the control mode for the subspace in which the occupant B is present, according to a combination of the first event X and the first event Y.

Similarly, for example, when the first event Y is a predetermined type of event, the mode determining unit 734 determines to set the suppression mode as the control mode for the subspace in which the occupant B is present, regardless of the type of another event related to the subspace in which the occupant B is present. The mode determining unit 734 may determine the control mode for the subspace in which the occupant B is present, according to a combination of the first event X and the first event Y.

In one embodiment, the transition event detecting unit 732 is configured to detect that an instruction from at least one occupant among the plurality of occupants is input, the instruction being related to enabling, disabling, or switching of the independent control mode. In this case, the mode determining unit 734 determines enabling, disabling, or switching of the independent control mode based on the above-described instruction.

In another embodiment, the transition event detecting unit 732 is configured to detect a first event. In this case, the mode determining unit 734 determines enabling or disabling, or switching of the independent control mode based on the type of the first event.

In another embodiment, the transition event detecting unit 732 is configured to detect a second event. In this case, the mode determining unit 734 is configured to determine enabling or disabling, or switching of the independent control mode based on the type of the second event.

In another embodiment, the transition event detecting unit 732 is configured to detect a third event. In this case, the mode determining unit 734 determines enabling or disabling, or switching of the independent control mode based on the type of the third event.

In still another embodiment, the mode determining unit 734 may determine to disable the independent control mode (i) when a predetermined time period has lapsed after the independent control mode is enabled, (ii) when the vehicle 100 has moved a predetermined distance after the independent control mode is enabled, or (iii) when a distance between a location of the vehicle 100 and a destination of the vehicle 100 is smaller than a predetermined value. The mode determining unit 734 may acquire information indicating the current location of the vehicle 100 and information indicating the destination of the vehicle 100, from the operation management unit 720.

In the present embodiment, the internal environment control unit 740 is configured to control an environment of the cabin space 120. In one embodiment, the internal environment control unit 740 is configured to acquire information indicating a control mode serving as a control target of the environment adjusting system 160, from the mode determining unit 734. The internal environment control unit 740 is configured to control an operation of the environment adjusting system 160 based on the information indicating the control mode described above.

In another embodiment, when the input/output system 150 accepts a command from the driver of the vehicle 100 for conveying a message from the driver of the vehicle 100 to another occupant, the internal environment control unit 740 acquires information indicating that the command is accepted, from the input/output system 150. In this case, the internal environment control unit 740 may control an operation of the environment adjusting system 160 such that the message from the driver is conveyed to another occupant regardless of the control mode determined by the mode determining unit 734.

In the present embodiment, the sight environment control unit 742 is configured to control a sight environment of the cabin space 120. When the independent control mode is enabled, the sight environment control unit 742 may control the sight environment for each subspace. For example, the sight environment control unit 742 is configured to control the sight environment for each subspace by controlling at least one of one or more displays 544, one or more dimming units 630, and one or more seat adjusting units 640.

In one embodiment, the sight environment control unit 742 is configured to, in a case where the mode determining unit 734 determines the suppression mode as the control mode, control the environment adjusting system 160 to (i) decrease illuminance of at least one of the first subspace and the second subspace, compared to that when the suppression mode is disabled, (ii) increase a distance between a first seat arranged in the first subspace and a second seat arranged in the second subspace, compared to that when the suppression mode is disabled, and/or, (iii) increase a degree of a back side of the first seat and a back side of the second seat facing each other, compared to that when the suppression mode is disabled.

In another embodiment, the sight environment control unit 742 is configured to, in a case where the mode determining unit 734 determines the promotion mode as the control mode, control the environment adjusting system 160 to (i) increase illuminance of at least one of the first subspace and the second subspace, compared to that when the promotion mode is disabled, (ii) decrease a distance between a first seat arranged in the first subspace and a second seat arranged in the second subspace, compared to that when the promotion mode is disabled, and/or (iii) increase a degree of a front side of the first seat and front side of the second seat facing each other, compared to that when the promotion mode is disabled.

In the present embodiment, the sound environment control unit 744 is configured to control a sound environment of the cabin space 120. When the independent control mode is enabled, the sound environment control unit 744 may control the sound environment for each subspace. For example, the sound environment control unit 744 is configured to control the sound environment for each subspace by controlling at least one of one or more seat adjusting units 640, one or more speakers, one or more traveling sound adjusting units 650, and one or more air conditioning units 620.

In one embodiment, the sound environment control unit 744 is configured to, in a case where the mode determining unit 734 determines the suppression mode as the control mode, control the environment adjusting system 160 to (i) increase a sound volume of a cancelling sound for cancelling at least a part of a voice uttered by at least one of the first occupant and the second occupant, compared to that when the suppression mode is disabled, (ii) increase a sound volume of a masking sound for masking at least a part of a voice uttered by at least one of the first occupant and the second occupant, compared to that when the suppression mode is disabled, and/or (iii) increase a sound volume of at least one of a traveling sound, an air conditioning sound, and an external sound in at least one of the first subspace and the second subspace.

In another embodiment, the sound environment control unit 744 is configured to control the environment adjusting system 160 to output a sound outside the vehicle 100 into the subspace corresponding to the driver's seat. In a case where a particular occupant hopes for a sound environment in which a sound from the outside can be heard, the sound environment control unit 744 may control the environment adjusting system 160 to output a sound from the outside into the subspace corresponding to the seat of the particular occupant. The particular occupant described above may be an occupant other than the driver.

In another embodiment, the sound environment control unit 744 is configured to, in a case where the mode determining unit 734 determines the promotion mode as the control mode, control the internal microphone 528 and the speaker 542 of the environment adjusting system 160 to output a voice uttered by one occupant into the subspace in which another occupant is present. The another occupant may be a particular occupant designated by the one occupant.

In the present embodiment, the air environment control unit 746 is configured to control an air environment of the cabin space 120. When the independent control mode is enabled, the air environment control unit 746 may control the air environment for each subspace. The air environment control unit 746 is configured to control the air environment for each subspace by controlling at least one of one or more air conditioning units 620 and one or more seat adjusting units 640. The air environment control unit 746 may control a flow of air in the cabin by adjusting at least one of a flow rate and orientation of air discharged from the air conditioning unit 620 and a location of the seat controlled by the seat adjusting unit 640.

In one embodiment, the sound environment control unit 744 is configured to, in a case where the mode determining unit 734 determines the suppression mode as the control mode, control the environment adjusting system 160 to increase an amount of air discharged from at least one of the first subspace and the second subspace to at least one of the outside of the vehicle 100 and the air cleaning unit 626, compared to that when the suppression mode is disabled. In another embodiment, the sound environment control unit 744 is configured to, in a case where the mode determining unit 734 determines the promotion mode as the control mode, control the environment adjusting system 160 to increase an amount of air circulating inside the shared space, compared to that when the promotion mode is disabled.

The operation management unit 720 may be an example of the drive information acquiring unit. The transition event detecting unit 732 may be an example of the instruction accepting unit, the occupant information acquiring unit, the first event detecting unit, the drive information acquiring unit, the second event detecting unit, the external information acquiring unit, and the third event detecting unit. The mode determining unit 734 may be an example of the space management system. The mode determining unit 734 may be an example of the control mode determining unit. The internal environment control unit 740 and each unit thereof may be an example of the environment control unit.

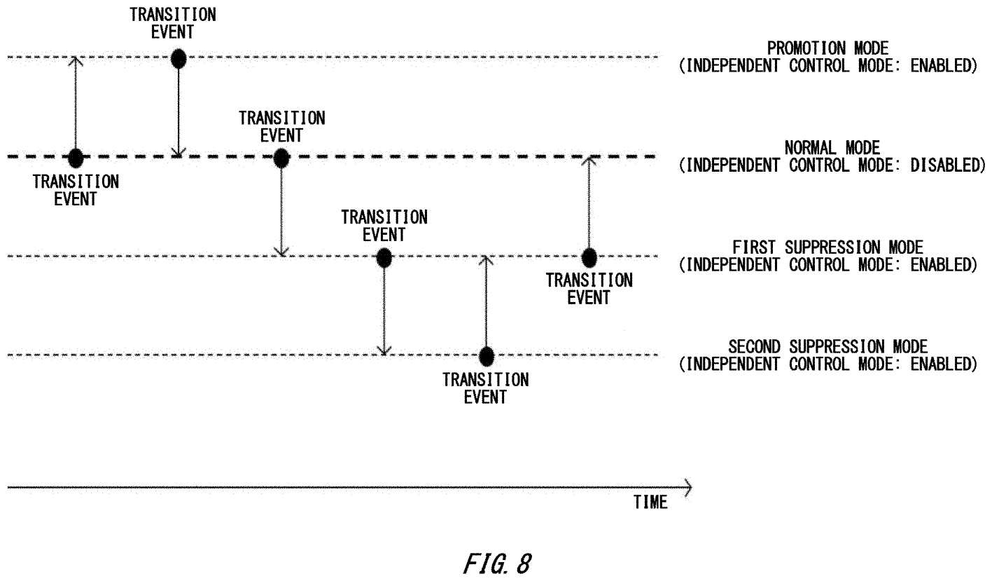

FIG. 8 schematically shows an example of a mode transition in the vehicle 100. As shown in FIG. 8, when the transition event detecting unit 732 detects a transition event, the mode determining unit 734 determines a control mode and the internal environment control unit 740 changes the control mode. In the present embodiment, in a case where the control mode of the environment adjusting system 160 transitions from the second suppression mode to the normal mode, the transition is intermediated by the first suppression mode. However, the transition of the control mode is not limited to the present embodiment.

In another embodiment, the control mode of the environment adjusting system 160 may transition from the second suppression mode to the normal mode without intermediation of the first suppression mode. For example, as described above, when a predetermined time period has lapsed after the independent control mode is enabled, when the vehicle 100 has moved a predetermined distance, or when the vehicle 100 has arrived at the destination or the vicinity of a passing point, the control mode of the environment adjusting system 160 may transition from the second suppression mode to the normal mode without intermediation of the first suppression mode.

In another embodiment, the control mode of the environment adjusting system 160 may transition from the second suppression mode to the promotion mode without intermediation of the first suppression mode and the normal mode. For example, in a case where a particular type of event or a combination of particular events is detected, the control mode of the environment adjusting system 160 transitions from the second suppression mode to the promotion mode without intermediation of the first suppression mode and the normal mode. Examples of the particular event include the transition event detecting unit 732 having detected actuation of a safety device or approaching of an emergency vehicle, the transition event detecting unit 732 having detected that the sound volume of a voice of one occupant is larger than a predetermined value, the transition event detecting unit 732 having detected that a content of a speech of one occupant contains a predetermined word, the input unit 512 having accepted a command from the driver of the vehicle 100, or the like.

In another embodiment, the control mode of the environment adjusting system 160 may transition from the promotion mode to the first suppression mode without intermediation of the normal mode. The control mode of the environment adjusting system 160 may transition from the promotion mode to the second suppression mode without intermediation of the normal mode and the first suppression mode.

In another embodiment, the environment adjusting system 160 may set a transition pattern of the control mode for each time of day. Examples of the time of day include a weekday, a holiday, a high day, early morning, forenoon, afternoon, daytime, evening, nighttime, midnight, or the like. The time of day may be designated by a user. For example, during the daytime, the control mode of the environment adjusting system 160 is set to be the normal mode, even if no event related to the promotion mode is detected for a certain time period. On the other hand, during the nighttime, the control mode of the environment adjusting system 160 automatically transitions from the normal mode to the suppression mode, if no event related to the promotion mode is detected for a certain time period.

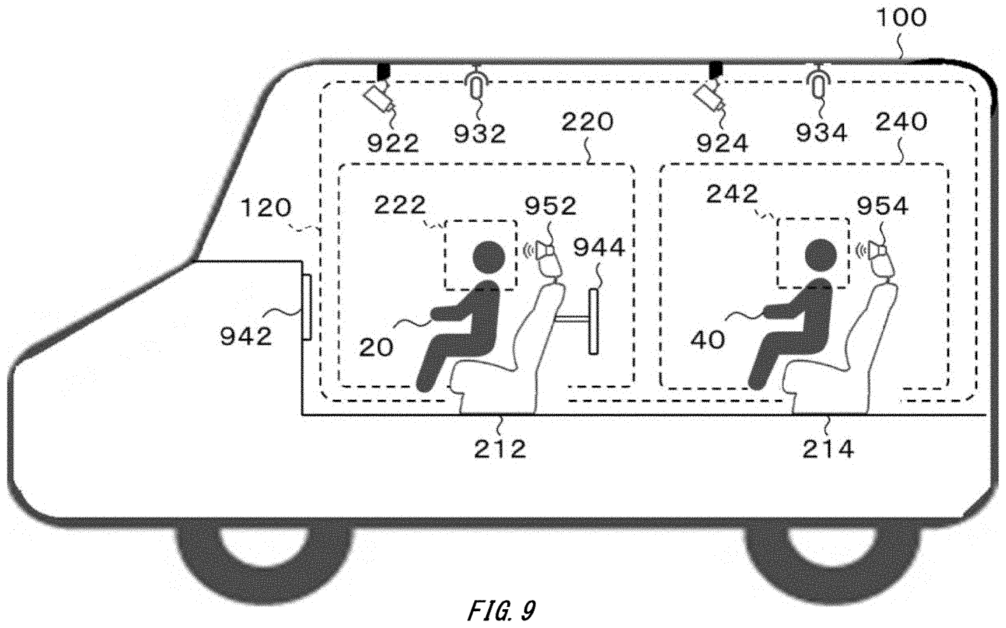

FIG. 9 schematically shows an example of a space management method in the vehicle 100. An example of an adjusting method of the visual environment in the cabin space 120 is described by using FIG. 9. An example of an adjusting method of the auditory environment in the cabin space 120 is described by using FIG. 9. Note that, in the present embodiment, an example of the space management method in the vehicle 100 is described in a case where communication between the occupant 20 and the occupant 40 is promoted or suppressed by adjusting a visual environment and an auditory environment, as an example. However, the space management method in the vehicle 100 is not limited to the present embodiment. In another embodiment, communication between the occupant 20 and the occupant 40 may be promoted or suppressed by adjusting one of the visual environment or the auditory environment.

In the present embodiment, the vehicle 100 includes an internal camera 922 and an internal camera 924 inside the housing 210. The vehicle 100 includes an internal microphone 932 and an internal microphone 934 inside the housing 210. The vehicle 100 includes a display 942 and a display 944 inside the housing 210. The vehicle 100 includes a speaker 952 and a speaker 954 inside the housing 210.

According to the present embodiment, in the promotion mode, an image of the occupant 20 captured by the internal camera 922 is displayed on the display 944. Moreover, an image of the occupant 40 captured by the internal camera 924 is displayed on the display 942. Thus, communication between the occupant 20 and the occupant 40 is promoted.

Note that, in another embodiment, an image of the occupant 20 captured by the internal camera 922 may be displayed on a display of the communication terminal 42 of the occupant 40. Moreover, an image of the occupant 40 captured by the internal camera 924 may be displayed on a display of the communication terminal 22 of the occupant 20.

According to the present embodiment, in the promotion mode, a voice of the occupant 20 collected by the internal microphone 932 is output from the speaker 954. Moreover, a voice of the occupant 40 collected by the internal microphone 934 is output from the speaker 952. Thus, communication between the occupant 20 and the occupant 40 is promoted.

Note that, in another embodiment, a voice of the occupant 20 collected by the internal microphone 932 may be output from an sound output device of the communication terminal 42 of the occupant 40. Text data or a sign language image of the voice described above may be displayed on the display of the communication terminal 42 of the occupant 40. Moreover, a voice of the occupant 40 collected by the internal microphone 934 may be output from an sound output device of the communication terminal 22 of the occupant 20. Text data or a sign language image of the voice described above may be displayed on the display of the communication terminal 22 of the occupant 20.

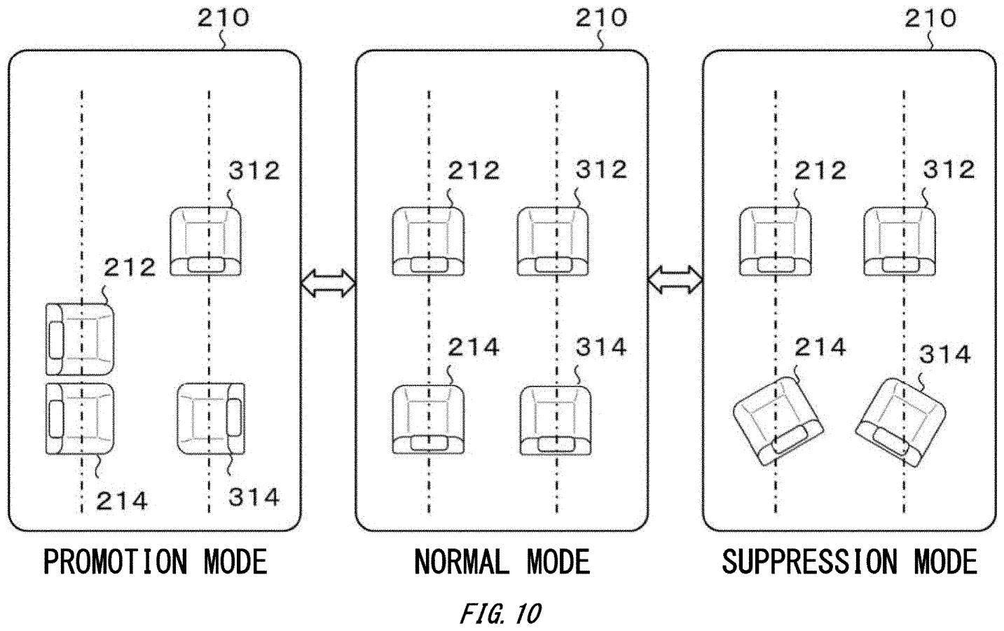

FIG. 10 schematically shows an example of the space management method in the vehicle 100. An example of an adjusting method of the visual environment in the cabin space 120 is described by using FIG. 10.

According to the present embodiment, in the promotion mode, positions and postures of the seat 212, the seat 214, and the seat 314 are changed. Specifically, the seat 212 and the seat 214 face the seat 314. Moreover, a distance between the seat 212 and the seat 214 and the seat 314 becomes smaller. Thus, communication between occupants using the seat 212, the seat 214, and the seat 314 is promoted.

According to the present embodiment, in the suppression mode, postures of the seat 214 and the seat 314 are changed. Specifically, the seat 212 and the seat 314 are directed to different directions from each other. Thus, communication between the occupants using the seat 212 and the seat 314 is suppressed.

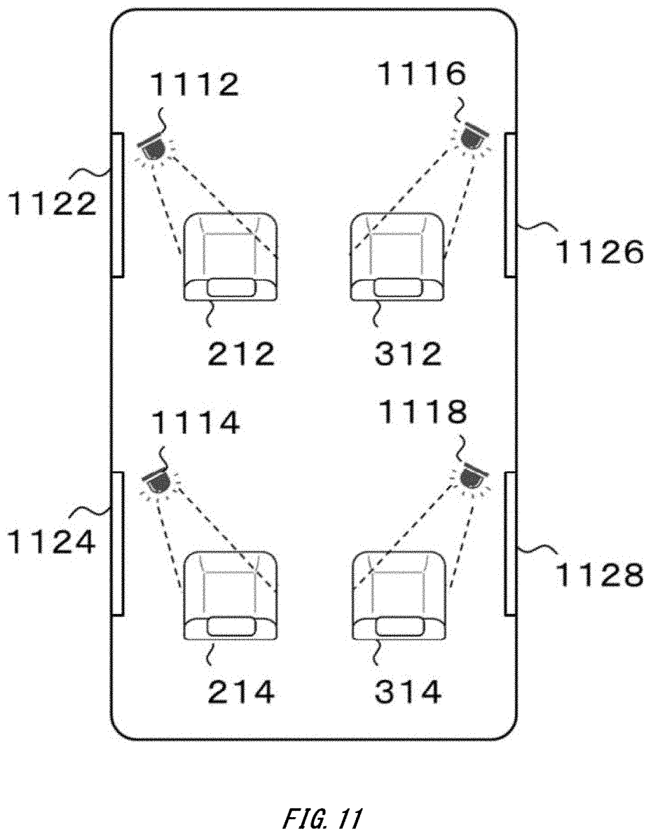

FIG. 11 schematically shows an example of the space management method in the vehicle 100. An example of an adjusting method of the visual environment in the cabin space 120 is described by using FIG. 11. In the present embodiment, the vehicle 100 includes a light 1112, a light 1114, a light 1116, and a light 1118 inside the housing 210. Moreover, a window 1122, a window 1124, a window 1126, and a window 1128 are arranged in the housing 210 of the vehicle 100. For example, dimming glass is used for the window 1122, the window 1124, the window 1126, and the window 1128.

According to the present embodiment, in the promotion mode, for example, the light 1114 irradiates light to the seat 214 and the light 1118 irradiates light to the seat 314. Thus, the occupant using the seat 214 and the occupant using the seat 314 can see each other's face well. As a result, communication between the occupants using the seat 212 and the seat 314 is promoted.

According to the present embodiment, in the suppression mode, for example, the window 1124 reduces transmittance of external light and the window 1128 reduces transmittance of external light. Thus, the occupant using the seat 214 and the occupant using the seat 314 cannot see each other's face well. As a result, communication between the occupants using the seat 212 and the seat 314 is suppressed.

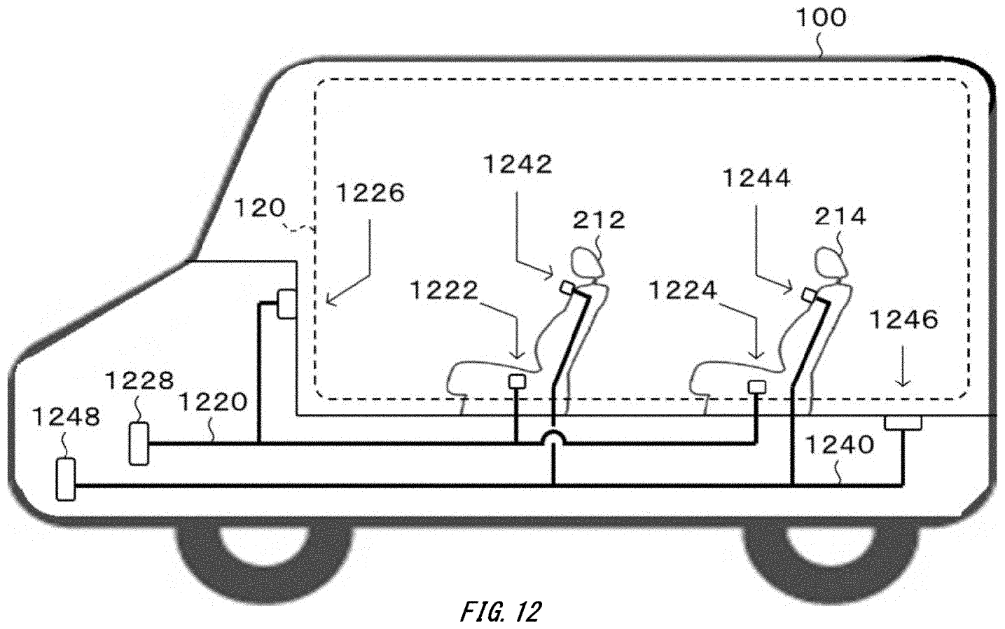

FIG. 12 schematically shows an example of the space management method in the vehicle 100. An example of an adjusting method of the olfactory environment in the cabin space 120 is described by using FIG. 12. In the present embodiment, the vehicle 100 includes an air supply pipe 1220, an air supply nozzle 1222, an air supply nozzle 1224, an air supply nozzle 1226, and an air supply fan 1228 inside the housing 210. The vehicle 100 includes an air exhaust pipe 1240, an air exhaust nozzle 1242, an air exhaust nozzle 1244, an air exhaust nozzle 1246, and an air exhaust fan 1248, inside the housing 210.

According to the present embodiment, in the promotion mode, air containing an identical aroma component is supplied from the air supply nozzle 1222 and the air supply nozzle 1224. Thus, communication between the occupants using the seat 212 and the seat 214 is promoted. In another embodiment, air sucked by the air exhaust nozzle 1242 may be supplied from the air supply nozzle 1224 to the subspace 240. Moreover, air sucked by the air exhaust nozzle 1244 may be supplied from the air supply nozzle 1222 to the subspace 220.

According to the present embodiment, in the suppression mode, air of the subspace 220 is discharged from the air exhaust nozzle 1242 to the outside of the vehicle 100. Moreover, clean air is supplied from the air supply nozzle 1222 to the cabin space 120, and serves as an air curtain that partitions the subspace 220 and the subspace 240. Similarly, air of the subspace 240 is discharged from the air exhaust nozzle 1244 to the outside of the vehicle 100. Moreover, clean air is supplied from the air supply nozzle 1224 to the cabin space 120, and serves as an air curtain that partitions the subspace 220 and the subspace 240. Thus, communication between the occupants using the seat 212 and the seat 214 is suppressed.

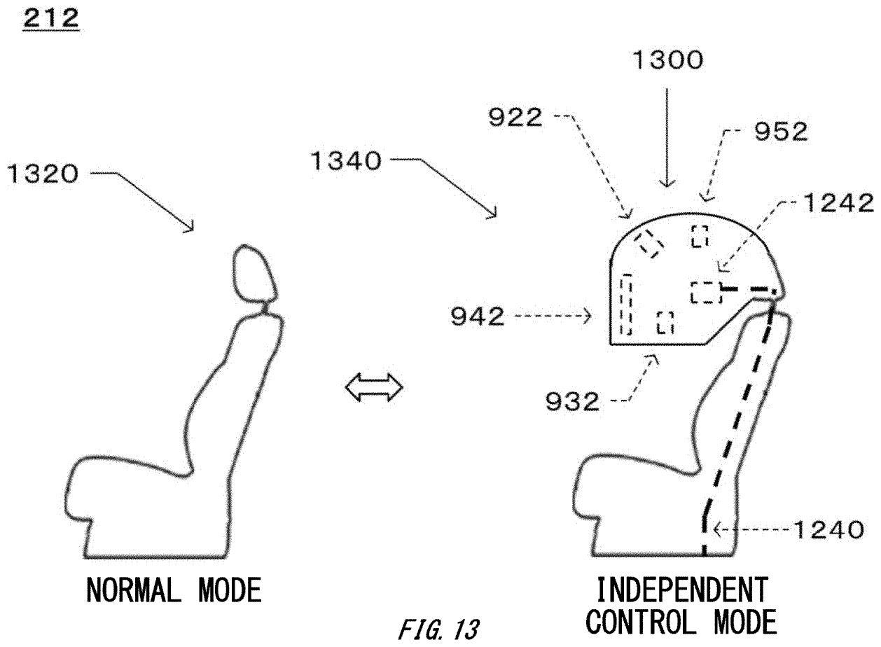

FIG. 13 schematically shows an example of the seat 212. In the embodiments according to FIG. 9 to FIG. 12, details of the vehicle 100 is described in a case where the environments of the subspace 220 and the subspace 240 are independently controlled without no part of the subspace 220 and the subspace 240 being physically partitioned, as an example. The present embodiment differs from the embodiment according to FIG. 9 to FIG. 12 in that a physical cover 1300 incorporated in the seat 212 expands and the environment of the subspace 222 set in the vicinity of the head of the occupant using the seat 212 is independently controlled.

As shown in FIG. 13, in the form 1320 at the time of the normal mode, the cover 1300 is housed in the headrest of the seat 212, for example. On the other hand, in the form 1340 at the time of the independent control mode, the cover 1300 expands and covers the subspace 222. In the present embodiment, an internal camera 922, an internal microphone 932, a display 942, a speaker 952, and an air exhaust nozzle 1242 may be arranged inside the cover 1300. Expansion and housing of the cover 1300 may be performed automatically or may be performed manually. Moreover, in another embodiment, the cover 1300 may not be housed and be expanded at all time or may be configured to be detachable.

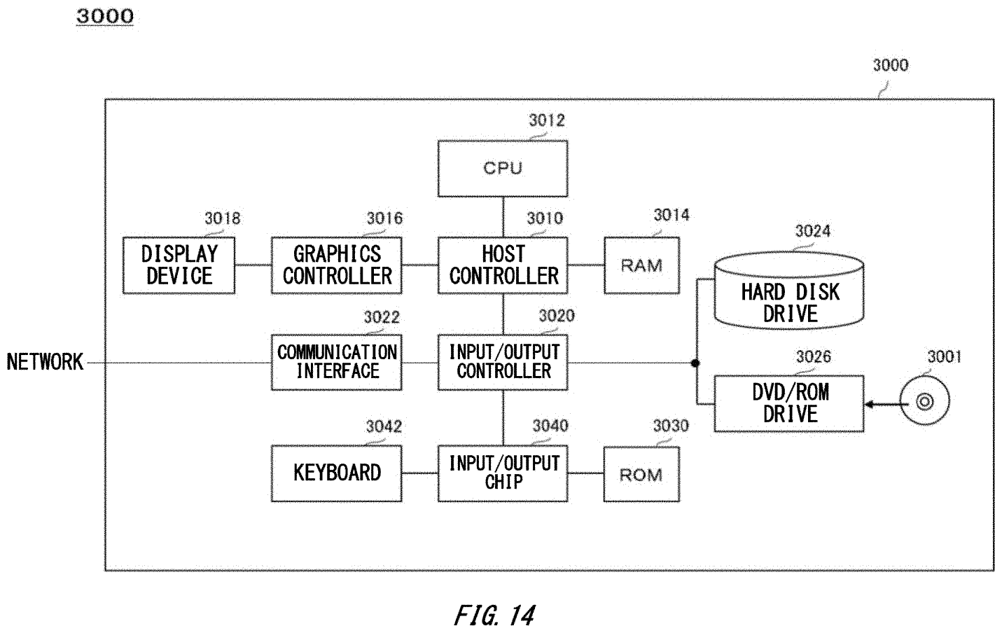

FIG. 14 shows an example of a computer 3000 in which a plurality of aspects of the present invention may be embodied entirely or partially. The vehicle 100 or a part thereof may be implemented by a computer 3000. For example, the control system 170 is implemented by the computer 3000.

A program that is installed in the computer 3000 can cause the computer 3000 to perform an operation associated with an apparatus according to the embodiment of the present invention or to function as one or more “units” of the apparatus, or cause the computer 3000 to perform the operation or the one or more units thereof, and/or cause the computer 3000 to perform processes of the embodiment of the present invention or steps thereof.

Such a program may be executed by the CPU 3012 to cause the computer 3000 to perform particular operations associated with some or all of the blocks of flowcharts and block diagrams described herein.

The computer 3000 in accordance with the present embodiment includes a CPU 3012, a RAM 3014, a graphics controller 3016, and a display device 3018, which are mutually connected by a host controller 3010. The computer 3000 also includes input/output units such as a communication interface 3022, a hard disk drive 3024, a DVD-ROM drive 3026 and an IC card drive, which are connected to the host controller 3010 via an input/output controller 3020. The computer also includes legacy input/output units such as a ROM 3030 and a keyboard 3042, which are connected to the input/output controller 3020 through an input/output chip 3040.

The CPU 3012 operates according to programs stored in the ROM 3030 and the RAM 3014, thereby controlling each unit. The graphics controller 3016 acquires image data generated by the CPU 3012 on a frame buffer or the like provided in the RAM 3014 or in itself, and causes the image data to be displayed on a display device 3018.

The communication interface 3022 performs communication with other electronic devices via a network. The hard disk drive 3024 stores programs and data that are used by the CPU 3012 within the computer 3000.

The DVD-ROM drive 3026 reads the programs or the data from the DVD-ROM 3001, and provides the hard disk drive 3024 with the programs or the data via the RAM 3014. The IC card drive reads programs and data from an IC card, and/or writes programs and data into the IC card.

The ROM 3030 stores therein a boot program or the like that is performed by the computer 3000 at the time of activation, and/or a program depending on the hardware of the computer 3000. The input/output chip 3040 may also connect various input/output units to the input/output controller 3020 via a parallel port, a serial port, a keyboard port, a mouse port or the like.

A program is provided by a computer readable storage medium, such as the DVD-ROM 3001 or the IC card. The program is read from the computer readable storage medium, installed into the hard disk drive 3024, RAM 3014, or ROM 3030, which are also examples of computer readable storage medium, and performed by the CPU 3012. The information processing described in these programs is read into the computer 3000, resulting in cooperation between a program and the above-described various types of hardware resources. An apparatus or method may be constituted by realizing the operation or processing of information in accordance with the usage of the computer 3000.

For example, when communication is performed between the computer 3000 and an external device, the CPU 3012 may perform a communication program loaded onto the RAM 3014 to command the communication interface 3022 to perform a communication processing, based on the processing described in the communication program. The communication interface 3022, under control of the CPU 3012, reads transmission data stored on a transmission buffer region provided in a recording medium such as the RAM 3014, the hard disk drive 3024, the DVD-ROM 3001, or the IC card, and transmits the read transmission data to a network or writes reception data received from a network into a reception buffer region or the like provided on the recording medium.

In addition, the CPU 3012 may cause all or a necessary portion of a file or a database to be read into the RAM 3014, the file or the database having been stored in an external recording medium such as the hard disk drive 3024, the DVD-ROM drive 3026 (DVD-ROM 3001), the IC card, etc., and perform various types of processing on the data on the RAM 3014. The CPU 3012 may then write back the processed data to the external recording medium.

Various types of information, such as various types of programs, data, tables, and databases, may be stored in the recording medium to undergo information processing. The CPU 3012 may perform various types of processing on the data read from the RAM 3014, which includes various types of operations, information processing, condition judging, conditional branch, unconditional branch, search/replacement of information, etc., as described throughout this disclosure and designated by an command sequence of programs, and writes the result back to the RAM 3014. In addition, the CPU 3012 may search for information in a file, a database, etc., in the recording medium. For example, when a plurality of entries, each having an attribute value of a first attribute associated with an attribute value of a second attribute, are stored in the recording medium, the CPU 3012 may search for an entry whose attribute value of the first attribute matches the condition a designated condition, from among the plurality of entries, and read the attribute value of the second attribute stored in the entry, thereby obtaining the attribute value of the second attribute associated with the first attribute satisfying the predetermined condition.

The above-described program or software modules may be stored in the computer readable storage medium on or near the computer 3000. In addition, a recording medium such as a hard disk or a RAM provided in a server system connected to a dedicated communication network or the Internet can be used as the computer readable storage medium, thereby providing the program to the computer 3000 via the network.

While the embodiments of the present invention have been described, the technical scope of the invention is not limited to the above-described embodiments. It is apparent to persons skilled in the art that various alterations or improvements can be added to the above-described embodiments. Further, to the extent that there is no technical contradiction, the matters described for the specific embodiment can be applied to other embodiments. Further, each component may have the feature similar to those of other components having the same names but different reference signs and numerals. It is also apparent from the scope of the claims that the embodiments added with such alterations or improvements can be included in the technical scope of the invention.

Note that the operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims for convenience, embodiments, or diagrams, it does not necessarily mean that the process must be performed in this order.

### EXPLANATION OF REFERENCES

20: occupant, 22: communication terminal, 40: occupant, 42: communication terminal, 100: vehicle, 120: cabin space, 130: drive system, 140: sensor system, 150: input/output system, 160: environment adjusting system, 170: control system, 210: housing, 212: seat, 214: seat, 220: subspace, 222: subspace, 240: subspace, 242: subspace, 312: seat, 314: seat, 320: subspace, 340: subspace, 412: partition wall, 414: door, 460: first space, 480: second space, 512: input unit, 514: output unit, 516: communication unit, 522: external camera, 524: external microphone, 526: internal camera, 528: internal microphone, 532: switch, 534: touch panel, 536: sound input unit, 538: gesture input unit, 542: speaker, 544: display, 620: air conditioning unit, 622: air supply unit, 624: air exhaust unit, 626: air cleaning unit, 630: dimming unit, 632: lighting unit, 634: external light adjusting unit, 640: seat adjusting unit, 650: traveling sound adjusting unit, 720: operation management unit, 732: transition event detecting unit, 734: mode determining unit, 740: internal environment control unit, 742: sight environment control unit, 744: sound environment control unit, 746: air environment control unit, 922: internal camera, 924: internal camera, 932: internal microphone, 934: internal microphone, 942: display, 944: display, 952: speaker, 954: speaker, 1112: light, 1114: light, 1116: light, 1118: light, 1122: window, 1124: window, 1126: window, 1128: window, 1220: air supply pipe, 1222: air supply nozzle, 1224: air supply nozzle, 1226: air supply nozzle, 1228: air supply fan, 1240: air exhaust pipe, 1242: air exhaust nozzle, 1244: air exhaust nozzle, 1246: air exhaust nozzle, 1248: air exhaust fan, 1300: cover, 1320: form, 1340: form, 3000: computer, 3001: DVD-ROM, 3010: host controller, 3012: CPU, 3014: RAM, 3016: graphics controller, 3018: display device, 3020: input/output controller, 3022: communication interface, 3024: hard disk drive, 3026: DVD-ROM drive, 3030: ROM, 3040: input/output chip, 3042: keyboard

What is claimed is:

1. A space management system for managing an environment of a shared space that is arranged inside a mobile body and can be used jointly by a first occupant and a second occupant, the space management system comprising:
a control mode determining unit configured to determine a control mode serving as a control target of an adjusting unit configured to adjust the environment of the shared space,
wherein the control mode determining unit is configured to determine enabling or disabling of an independent control mode for independently adjusting an environment of a first subspace, which is a part of the shared space, where the first occupant is present and an environment of a second subspace, which is a part of the shared space, where the second occupant is present.

2. The space management system according to claim 1, wherein, inside the shared space, there is no space surrounded by a partition or a wall in all directions, which is an isolated space for exclusive use by some of occupants of the mobile body.

3. The space management system according to claim 1, wherein the adjusting unit is configured to adjust the environment of the shared space by acting on at least one of a visual sense, an auditory sense, and an olfactory sense of an occupant who is present inside the shared space.

4. The space management system according to claim 1, further comprising:
an instruction accepting unit configured to accept an instruction from at least one of the first occupant and the second occupant, the instruction being related to the enabling, the disabling, or switching of the independent control mode,
wherein the control mode determining unit is configured to determine the enabling, the disabling, or the switching of the independent control mode, based on the instruction accepted by the instruction accepting unit.

5. The space management system according to claim 1, further comprising:
an occupant information acquiring unit configured to acquire information indicating at least one of a gesture and a voice of the first occupant and the second occupant; and
a first event detecting unit configured to detect occurrence of a predetermined first event, based on the information acquired by the occupant information acquiring unit,
wherein the control mode determining unit is configured to determine the enabling or the disabling or switching of the independent control mode, based on a type of the first event detected by the first event detecting unit.

6. The space management system according to claim 5, wherein the first event detecting unit is configured to detect the occurrence of the first event by analyzing at least one of (i) a voice uttered by at least one of the first occupant and the second occupant toward another occupant and (ii) an action performed by at least one of the first occupant and the second occupant toward another occupant.

7. The space management system according to claim 1, further comprising:
a drive information acquiring unit configured to acquire information indicating a state of a driving unit configured to drive the mobile body; and
a second event detecting unit configured to detect occurrence of a predetermined second event, based on the information acquired by the drive information acquiring unit,
wherein the control mode determining unit is configured to determine the enabling or the disabling or switching of the independent control mode, based on a type of the second event detected by the second event detecting unit.

8. The space management system according to claim 1, further comprising:
an external information acquiring unit configured to acquire information indicating a state outside the mobile body; and
a third event detecting unit configured to detect occurrence of a predetermined third event, based on the information acquired by the external information acquiring unit,
wherein the control mode determining unit is configured to determine the enabling or the disabling or switching of the independent control mode, based on a type of the third event detected by the third event detecting unit.

9. The space management system according to claim 1, wherein the control mode determining unit is configured to determine disabling of the independent control mode, (i) when a predetermined time period has lapsed after the independent control mode is enabled, (ii) when the mobile body has moved a predetermined distance after the independent control mode is enabled, or (iii) when a distance between a location of the mobile body and a destination of the mobile body is smaller than a predetermined value.

10. The space management system according to claim 1, further comprising an environment control unit configured to control an operation of the adjusting unit based on the control mode determined by the control mode determining unit.

11. The space management system according to claim 10, further comprising:
an command accepting unit configured to accept an command from a driver of the mobile body for conveying a message from the driver to another occupant,
wherein the environment control unit is configured to control an operation of the adjusting unit such that the message from the driver is conveyed regardless of the control mode determined by the control mode determining unit, when the command accepting unit accepts the command from the driver.

12. The space management system according to claim 10, wherein the independent control mode includes a plurality of independent control modes, and the control mode determining unit is configured to determine one of the plurality of independent control modes as the control mode serving as the control target.

13. The space management system according to claim 12, wherein the plurality of independent control modes includes:
(a) a suppression mode for adjusting the environment of the shared space such that communication between the first occupant and the second occupant is suppressed; and
(b) a promotion mode for adjusting the environment of the shared space such that communication between the first occupant and the second occupant is promoted.

14. The space management system according to claim 13,
wherein, the environment control unit is configured to
in a case where the control mode determining unit determines the suppression mode as the control mode
control the adjusting unit to
(i) decrease illuminance of at least one of the first subspace and the second subspace, compared to that when the suppression mode is disabled,
(ii) increase a distance between a first seat arranged in the first subspace and a second seat arranged in the second subspace, compared to that when the suppression mode is disabled, and/or,
(iii) increase a degree of a back side of the first seat and a back side of the second seat facing each other, compared to that when the suppression mode is disabled.

15. The space management system according to claim 13,
wherein, the environment control unit is configured to
in a case where the control mode determining unit determines the promotion mode as the control mode
control the adjusting unit to
(i) increase illuminance of at least one of the first subspace and the second subspace, compared to that when the promotion mode is disabled,
(ii) decrease a distance between a first seat arranged in the first subspace and a second seat arranged in the second subspace, compared to that when the promotion mode is disabled, and/or
(iii) increase a degree of a front side of the first seat and front side of the second seat facing each other, compared to that when the promotion mode is disabled.

16. The space management system according to claim 13,
wherein, the environment control unit is configured to
in a case where the control mode determining unit determines the suppression mode as the control mode
control the adjusting unit to
(i) increase a sound volume of a cancelling sound for cancelling at least a part of a voice uttered by at least one of the first occupant and the second occupant, compared to that when the suppression mode is disabled,
(ii) increase a sound volume of a masking sound for masking at least a part of a voice uttered by at least one of the first occupant and the second occupant, compared to that when the suppression mode is disabled, and/or
(iii) increase a sound volume of at least one of a traveling sound, an air conditioning sound, and an external sound in at least one of the first subspace and the second subspace.

17. The space management system according to claim 13,
wherein, the environment control unit is configured to
in a case where the first subspace or the second subspace corresponds to a driver's seat of the mobile body
control the adjusting unit to
output a sound from the outside of the mobile body to a subspace corresponding to the driver's seat, which is either the first subspace or the second subspace.

18. The space management system according to claim 13,
wherein the adjusting unit comprises:
a sound collecting unit configured to collect a sound; and
a sound output unit configured to output the sound collected by the sound collecting unit,
wherein, the environment control unit is configured to
in a case where the control mode determining unit determines the promotion mode as the control mode
control the sound collecting unit and the sound output unit of the adjusting unit to
(i) output a voice uttered by the first occupant to the second subspace, and/or
(ii) output a voice uttered by the second occupant to the first subspace.

19. The space management system according to claim 13,
wherein, the environment control unit is configured to
in a case where the control mode determining unit determines the suppression mode as the control mode
control the adjusting unit to
increase an amount of air discharged from at least one of the first subspace and the second subspace to at least one of the outside of the mobile body and an air cleaning unit arranged in the mobile body, compared to that when the suppression mode is disabled.

20. The space management system according to claim 13,
wherein, the environment control unit is configured to
in a case where the control mode determining unit determines the promotion mode as the control mode
control the adjusting unit to
increase an amount of air circulating inside the shared space, compared to that when the promotion mode is disabled.

21. The space management system according to claim 13, wherein the suppression mode includes a plurality of suppression modes, and the plurality of independent control modes includes the plurality of suppression modes having different degrees of suppressing communication between the first occupant and the second occupant.

22. The space management system according to claim 21, wherein the plurality of suppression modes includes:
(i) a first suppression mode for diminishing communication between the first occupant and the second occupant; and
(ii) a second suppression mode for shutting off communication between the first occupant and the second occupant.

23. The space management system according to claim 1, further comprising the adjusting unit.

24. A mobile body having provided therein a shared space that can be used jointly by a plurality of occupants, the mobile body comprising:
the space management system according to claim 1; and
a driving unit configured to drive the mobile body.

25. A non-transitory computer readable recording medium having recorded thereon a program for causing a computer to execute a space management method for managing an environment of a shared space that is arranged inside a mobile body and can be used jointly by a first occupant and a second occupant, the space management method comprising:
determining a control mode serving as a control target of an adjusting unit configured to adjust the environment of the shared space,
wherein the determining of the control mode includes determining enabling or disabling of an independent control mode for independently adjusting an environment of a first subspace, which is a part of the shared space, where the first occupant is present and an environment of a second subspace, which is a part of the shared space, where the second occupant is present.

26. A space management method for managing an environment of a shared space that is arranged inside a mobile body and can be used jointly by a first occupant and a second occupant, the space management method comprising:
determining a control mode serving as a control target of an adjusting unit configured to adjust the environment of the shared space,
wherein the determining of the control mode includes determining enabling or disabling of an independent control mode for independently adjusting an environment of a first subspace, which is a part of the shared space, where the first occupant is present and an environment of a second subspace, which is a part of the shared space, where the second occupant is present.
